(19) United States
(12) Patent Application Publication
(10) Pub. No.: US 2023/0271829 A1
(43) Pub. Date: Aug. 31, 2023

(54) ATR-Based Hydrogen Process and Plant

(71) Applicant: HALDOR TOPSØE A/S, Kgs. Lyngby (DK)

(72) Inventors: Steffen Spangsberg CHRISTENSEN, Køge (DK); Arunabh SAHAI, Faridabad, Haryana (IN); Kim AASBERG-PETERSEN, Allerød (DK)

(73) Assignee: TOPSOE A/S, Kgs. Lyngby (DK)

(21) Appl. No.: 18/006,586

(22) PCT Filed: Aug. 16, 2021
(86) PCT No.: PCT/EP2021/072729

§ 371 Date: Jan. 24, 2023

(30) Foreign Application Priority Data
Aug. 17, 2020 (IN) 202011035429
Oct. 8, 2020 (DK) PA 2020 01154

(51) Int. Cl. C01B 3/38; C01B 3/48

(52) U.S. Cl. CPC C01B 3/382; C01B 3/48; C01B 2203/0244; C01B 2203/0283; C01B 2203/0288; C01B 2203/148; C01B 2203/0822; C01B 2203/1628; C01B 2203/146; C01B 2203/1264; C01B 2203/1241; C01B 2203/0475; C01B 2203/142

(57) ABSTRACT

A plant and process for producing a hydrogen rich gas and improved carbon capture are provided, said process comprising the steps of: reforming a hydrocarbon feed by optional prereforming, autothermal reforming (ATR), yet no primary reforming, thereby obtaining a synthesis gas; shifting said synthesis gas in a shift section including a high temperature shift step; removal of CO₂ upstream hydrogen purification unit, thereby producing a hydrogen rich stream and an off-gas stream, and where at least part of the off-gas stream is recycled to the process, thus to the ATR and optional prereforming, and/or to the shift section.

### FIELD OF THE INVENTION

The present invention relates to a plant and process for the production of hydrogen from a hydrocarbon feed comprising reforming, shift conversion, CO₂-removal and hydrogen purification. In particular, the present invention concerns a plant and process for producing hydrogen from a hydrocarbon feed, in which the hydrocarbon feed is subjected to reforming in an autothermal reformer (ATR) for generating a synthesis gas, in which the reforming may include prereforming yet it is conducted without primary reforming, subjecting the synthesis gas to shift conversion step in a shift section including one or more shift steps for enriching the synthesis gas in hydrogen, subjecting the shifted gas to a carbon dioxide removal step and then treating the shifted gas in a hydrogen purification unit, such as a pressure swing adsorption (PSA) unit, whereby a H₂-rich stream is produced as well as a PSA-off-gas stream, and where at least part of the off-gas stream is recycled to the to the ATR and optional pre-reforming, and/or to the shift section.

### BACKGROUND

Following today's demand and competitiveness in hydrogen production, significant efforts have been put into developing optimized production for hydrogen plants, with the objective to improve overall energy efficiency and reduce capital cost. The need for more cost-efficient hydrogen production has spurred the development of technology and catalysts for large-scale hydrogen production units, in order to benefit from economy of scale.

Applicant's latest innovations within hydrogen production technology and the development of a new generation of state-of-the-art catalysts ensure highly cost-efficient hydrogen production and high plant reliability also for large single line capacities.

U.S. Pat. No. 9,028,794 discloses a method for producing hydrogen with reduced carbon dioxide emissions from a hydrocarbon mixture. The hydrocarbon mixture is reformed so as to produce a synthesis gas that is cooled, then treated in a shift reactor so as to be enriched with H₂ and CO₂. Optionally dried, said mixture is treated in a PSA hydrogen purification unit in order to produce hydrogen. The PSA-off gas is thus further treated in a second shift step and optionally also passed through another PSA.

U.S. Pat. No. 9,481,573 discloses a method of re-distributing CO₂ balance from reformer furnace flue gas to the high pressure syngas exit water gas shift reaction unit, comprising: using a primary reformer (i.e. conventional steam methane reformer, SMR), shift, amine wash to remove CO₂, a low recovery PSA to produce hydrogen and a PSA purge gas (PSA-off gas) which is recycled to the reformer furnace as fuel such that no additional supplemental fuel to the reformer furnace is required. By low recovery is meant hydrogen recovery between about 50 and 65%.

EP 2103569 B1 discloses a method for generating hydrogen and/or syngas in a production facility where little or no export steam is produced. Most or all of the steam produced from the waste heat from the process is used in the steam-hydrocarbon reformer. Reformed gas is passed through a shift conversion step, CO₂-removal step and then to a pressure swing adsorption system for H₂ purification. CO₂ is removed from the pressure swing adsorber residual gas (PSA-off gas) prior to recycling the residual gas to the reformer for use as feed and as fuel. A portion of the PSA-off gas may be used in the shift section.

U.S. Pat. No. 8,187,363 discloses a process for improving the thermodynamic efficiency of a hydrogen generation system. This includes producing a syngas stream in a reformer, wherein the reformer has a combustion zone. The patent includes introducing a syngas stream into a pressure swing adsorption unit, thereby producing a product hydrogen stream and a tail gas stream. The patent also includes heating the tail gas stream by indirect heat exchange with a heat source, thereby producing a heated tail gas stream; and introducing the heated tail gas stream into the combustion zone of the reformer.

US 2018237297 discloses a method for obtaining a hydrogen rich gas from a natural gas comprising gas stream comprising: (1) feeding said natural gas comprising gas and an appropriate amount of steam to a reforming unit comprising at least a steam methane reformer (SMR) and optionally a pre-reforming reactor up stream of the SMR, obtaining a first effluent; (2) feeding said first effluent and optionally an appropriate amount of steam through a high, medium or low temperature shift reactor(s) or a combination thereof to convert at least part of the carbon monoxide and water into hydrogen and carbon dioxide, to obtain a second effluent; (3) optionally, removing bulk water from the second effluent obtained in steps (1) or (2); (4) feeding the second effluent of step (2) and/or (3) through a pressure swing adsorption (PSA) unit operated such that a hydrogen rich gas stream is obtained wherein an off gas is added to the natural gas comprising gas stream and/or the first effluent obtained in step (1), wherein the off gas provided upstream of the reforming unit is mixed with steam prior to being added to the natural gas comprising gas stream.

U.S. Pat. No. 8,715,617 discloses a hydrogen production process wherein steam and a hydrocarbon feed is reacted in a prereformer, the prereformed intermediate is further reacted in an oxygen-based reformer, the reformate is shifted and then separated by a pressure swing adsorber having a plurality of adsorption beds to form a H₂ product stream and a tail gas, a first portion of the tail gas is recycled to the prereformer and/or the oxygen-based reformer, and a second portion of the tail gas is recycled to the pressure swing adsorber.

US2010/0310949 A1 describes a process for producing hydrogen by a steam reforming by means of optional prereforming in a prereforming unit and subsequent primary reforming in a tubular reformer, in which a portion of the hydrogen product from a downstream hydrogen purification unit is used as fuel in the tubular reformer and a portion of the by-product gas (off-gas) is recycled back into the process, i.e. to the feed side of the optional pre-reforming unit or to the feed side of the tubular reformer.

GB2571136 A describes a process and plant for producing a H₂-rich stream from a hydrocarbon feed. The plant comprises a pre-reformer, gas heated reformer (primary reformer), autothermal reformer, water gas shift section, CO₂ removal section and hydrogen purification unit. Rest gas (off gas) from the hydrogen purification unit is utilized for fuel in fired heaters for preheating feed gases. Since a gas heated reformer is used, the output gas thereof, corresponding to the inlet to the autothermal reformer, is 400-800 C, or 450-700 C or 500-600 C.

US2020055738 A1 describes a process and plant for the synthesis of ammonia from natural gas feed, the plant comprising a prereformer (PRE), autothermal reformer (ATR), shift section (SHF), CO₂ removal section (CDR) in an amine wash unit for producing a CO₂-rich stream and a H₂-rich stream, optional methanator (MET), ammonia synthesis section (SYN), hydrogen recovery section (HRU), a fired heater (AUX) for preheating of the natural gas feed and using part of the H₂-rich stream as fuel.

### SUMMARY

It is an object of the present invention to reduce consumption of hydrocarbon feed and fuel in a hydrogen plant and/or process, thereby increasing energy efficiency.

It is another object of the present invention to provide a plant and/or process with overall lower investment and operating costs compared to plants based on steam methane reformers (tubular reformers) or more generally comprising primary reforming, and without compromising energy efficiency.

It is yet another object of the present invention to recover, i.e. capture, as much as possible of the carbon present in the hydrocarbon feed, whilst at the same time not compromising with the energy efficiency.

These and other objects are solved by the present invention.

Accordingly, in a first aspect, a plant for producing a H₂-rich stream from a hydrocarbon feed is provided. The plant comprises:
an autothermal reformer (ATR), said ATR being arranged to receive a hydrocarbon feed and convert it to a stream of syngas;
a shift section, said shift section comprising a high temperature shift unit, said high temperature shift unit being arranged receive a stream of syngas from the ATR and shift it in a high temperature shift step, thereby providing a shifted syngas stream;
a CO₂ removal section, arranged to receive the shifted syngas stream from said shift section and separate a CO₂-rich stream from said shifted syngas stream, thereby providing a CO₂-depleted shifted syngas stream,
a hydrogen purification unit, arranged to receive said CO₂-depleted shifted syngas stream, from said CO₂ removal section, and separate it into a high-purity H₂ stream, i.e. said H₂-rich stream, and an off-gas stream;
wherein said plant is absent of a primary reforming unit;
wherein said plant is arranged to feed at least a part of the off-gas stream (9) from said hydrogen purification unit as an off-gas recycle stream (9′) to the feed side of the ATR; and/or as an off-gas recycle stream to the feed side of the shift section; and
wherein the plant is arranged to provide an inlet temperature of said hydrocarbon feed to the ATR of below 600° C., such as 550° C. or 500° C. or lower, for instance 300-400° C.

Also provided, in a second aspect of the invention, as recited farther below, is a process for producing a H₂-rich stream from a hydrocarbon feed, using the plant as defined herein.

Further details of the invention are set out in the following description, following figures, aspects and the dependent claims.

The plant is arranged to provide an inlet temperature of said hydrocarbon feed to the ATR of below 600° C., such as 550° C. or 500° C. or lower, for instance 300-400° C. The above temperatures are lower than the typical ATR inlet temperatures of 600-700° C. and which are normally desirable to reduce oxygen consumption in the ATR. Hence, the plant is purposely and counterintuitively arranged for having a lower ATR inlet temperature. By having a lower ATR inlet temperature, suitably 550° C. or lower, such as 500° C. or lower, e.g. 300-400° C., the amount of heat required in a heater unit for pre-heating the hydrocarbon, e.g. a fired heater, is significantly reduced, thereby enabling a much smaller fired heater, or reducing the number of fired heaters. By having an inlet temperature to the ATR of 300-400° C., the use of a fired heater can be completely obliviated as well.

Thereby it is now possible to saving up to the entire CO₂ emission from the flue gas from a fired heater. The carbon footprint of the plant is thereby significantly reduced.

Reduction in duty requirement of feed gas preheating not only reduces the fired heater size, but also reduces the off-gas (from the hydrogen purification unit, e.g. PSA off-gas) fuel requirement in said fired heater and thereby making higher amount of the off-gas available for recycle to the front-end section, e.g. to the ATR, or optionally to the shift section. Higher recycle of the off-gas leads to more carbon capture and better overall hydrogen recovery due to less hydrogen loss as fuel via off-gas being fired (used as fuel) in the fired heater. This enables lower hydrocarbon feed e.g. natural gas consumption. Hence, lower steam-to-carbon ratio (S/C) along with the off-gas recycle to e.g. the ATR enables lower plant cost, lower hydrocarbon feed consumption, lower fuel gas consumption and better carbon capture.

The flue gas from a fired heater would normally be emitted at low pressure, thus the energy and capital cost for CO₂-removal from the low-pressure flue gas is high. For instance, in an amine wash CO₂ removal unit the energy requirement for compressing the flue gas and energy required for regenerating the CO₂ is significantly higher which otherwise would be lesser if CO₂ is recovered from the shifted syngas. Moreover, additional unit operations are needed to cool and purify the flue gas which increases the capital expenses. The impurities in flue gas typically are SOₓ and NOₓ which are not suitable in an amine wash type CO₂ removal unit. Thus, the present invention removes CO₂ from the process gas itself. The invention enables therefore also reducing the capital expenses in order to produce a high purity H₂ stream, e.g. with 99.9 vol. % H₂, and 90% or more carbon capture.

In an embodiment according to the first aspect of the invention, said plant further comprises at least one prereformer unit arranged upstream the ATR, said prereformer unit being arranged to pre-reform said hydrocarbon feed prior to it being fed to the ATR and wherein said plant is arranged to feed at least a part of the off-gas stream from said hydrogen purification unit as an off-gas recycle stream to the feed side of the prereformer unit.

The provision of the off-gas recycle stream from the hydrogen purification unit to the feed side of the prereformer unit improves the capture of carbon in the hydrocarbon feed. The off-gas recycle contains some methane, for instance 2-4 vol. %, which is advantageously converted in the prereformer. By reducing the methane content of the off-gas via prereforming, a higher carbon capture of the hydrocarbon feed is possible, such as 95% or more carbon capture. The CO₂ concentration in the CO₂-rich stream is accordingly also increased.

In an embodiment according to the first aspect of the invention, the plant comprises two or more adiabatic prereformers arranged in series with interstage preheater(s) i.e. in between prereformer preheater(s).

In the prereforming unit(s) all higher hydrocarbons can be converted to carbon oxides and methane, but the prereforming unit(s) are also advantageous for light hydrocarbons. Providing the prereforming unit(s), hence prereforming step(s), may have several advantages including reducing the required O₂ consumption in the ATR and allowing higher inlet temperatures to the ATR since cracking risk by preheating is minimized. Furthermore, the prereforming unit(s) may provide an efficient sulphur guard resulting in a practically sulphur free feed gas entering the ATR and the downstream system. The prereforming step(s) may be carried out at temperatures between 300-650° C., preferably 390-480° C.

As used herein, the terms “prereformer”, “prereformer unit” and “prereforming unit”, are used interchangeably.

In another embodiment, the plant is absent of a prereformer unit. Plant size and attendant costs are thereby reduced.

In an embodiment according to the first aspect of the invention, said off-gas recycle stream is mixed with hydrocarbon feed before being fed to the feed side of the ATR. It would thus be understood, that the off-gas recycle can be led directly to e.g. the ATR, and/or being mixed with hydrocarbon feed before entering the ATR.

In another embodiment according to the first aspect of the invention, said off-gas recycle stream is mixed with hydrocarbon feed before being fed to the feed side of the pre-reformer unit.

In an embodiment according to the first aspect of the invention, said plant further comprises a hydrogenator unit and a sulfur absorption unit arranged upstream said at least one pre-reformer unit or said ATR, wherein said plant is arranged to feed at least a part of the off-gas stream from said hydrogen purification unit as an off-gas recycle stream to the feed side of the hydrogenator unit. In another particular embodiment, the plant is arranged for the outlet temperature of said sulfur absorption unit matching the inlet temperature of the ATR, suitably 300-400° C., for instance 340-370° C. such as about 350° C. No heater, e.g. no fired heater, is thereby required to preheat the hydrocarbon feed to the ATR. The saving of the entire CO₂ emission from the flue gas of the fired heater is thereby achievable.

As used herein, the term “feed side” means inlet side or simply inlet. For instance, the feed side of the ATR means the inlet side of the ATR, the feed side of the shift section means the inlet side of the high temperature shift unit or the inlet side of any downstream shift unit downstream in said shift section, such as a medium temperature shift unit.

As used herein, the term “syngas” means synthesis gas, which is a fuel gas mixture rich in carbon monoxide and hydrogen. Syngas normally contains also some carbon dioxide.

As used herein, the term “high-purity H₂-stream” is interchangeable with the term “H₂-rich stream” and represents the hydrogen stream withdrawn from the hydrogen purification unit.

As used herein, the term CO₂-rich stream means a stream containing 95 vol. % or more, for instance 99.5 vol. % of carbon dioxide. The CO₂-depleted shifted gas stream means a stream containing 1000 ppm carbon dioxide or less, for instance 500 ppmv carbon dioxide or 50 ppmv.

As used herein, the term “flue gas” means a gas obtained from burning hydrocarbon streams and/or hydrogen, the flue gas containing mainly CO₂, N₂ and H₂O with traces of CO, Ar and other impurities, plus a little surplus of O₂.

In an embodiment according to the first aspect of the invention, the plant is arranged for adding steam to: the hydrocarbon feed, the ATR, and/or to the shift section.

In an embodiment according to the first aspect of the invention, said plant is arranged to provide a steam-to-carbon ratio in the ATR of 0.4 or higher, such as 0.6 or higher, or such as 0.8 or higher, yet said steam-to-carbon ratio being not greater than 2.0, such as 0.9, 1.0 or higher, for instance in the range 1.0-2.0, and/or wherein the ATR is arranged to operate at 20-30 barg, such as 24-28 barg. These steam-to-carbon ratios are higher than what normally would be expected to be used for ATR operation, which typically are in the range 0.3-0.6. Also, the pressures are lower than what normally would be expected for ATR operation which typically are 30 barg or higher, for instance 30-40 barg.

Operating the plant at the low steam-to-carbon ratio of e.g. 0.4 or 0.6 in the ATR enables lower energy consumption and reduced equipment size as less steam/water is carried over in the plant.

As used herein the term “steam-to-carbon ratio in the ATR” (alternatively denoted S/C-ratio or steam/carbon ratio) means steam-to-carbon molar ratio, which is defined by the molar ratio of all steam added to the hydrocarbon feed and the ATR, i.e. excluding any steam added to the shift section downstream, to all the carbon in hydrocarbons in the feed gas (hydrocarbon feed), which is optionally prereformed, and reformed in the ATR.

More specifically, the steam/carbon ratio is defined as the ratio of all steam added to the reforming section upstream the shift section e.g. the high temperature shift section, i.e. steam which may have been added to the reforming section via the feed gas, oxygen feed, by addition to the ATR and the carbon in hydrocarbons in the feed gas (hydrocarbon feed) to the reforming section on a molar basis. The steam added includes only the steam added to the ATR and upstream the ATR.

As used herein the term “syngas from the ATR” means syngas at the exit of the ATR and to which no steam has been added, e.g. any additional steam used for the downstream shift section. It would therefore be understood that said steam to carbon ratio is the steam/carbon ratio on molar basis in the reforming section. The reforming section includes the ATR and any prereformer, but not the shift section.

Operating the plant at the low steam-to-carbon ratio of e.g. 0.4 or 0.6 in the ATR enables lower energy consumption and reduced equipment size as less steam/water is carried over in the plant. The present invention provides also a plant where the ATR is arranged for its pressure being lower than what normally would be expected for ATR operation which typically is 30 barg or higher, for instance 30-40 barg. This enables the capture of even more carbon, e.g. 97% or more of the carbon in the hydrocarbon feed whilst at the same time not compromising the energy efficiency, in particular when combined with the steam-to-carbon ratio in the ATR being 0.4 or 0.6 or higher, e.g. 0.8.

The plant is without i.e. is absent of a steam methane reformer unit (SMR) upstream the ATR Hence the plant is absent of a primary reforming unit and thus there is no primary reforming step. The primary reforming unit may also include a convection reforming unit such as a gas heated reforming unit. Accordingly, the reforming section of the plant comprises an ATR and optionally also a pre-reforming unit, yet there is no steam methane reforming (SMR) unit, i.e. the use of e.g. a conventional SMR (also normally referred as radiant furnace, or tubular reformer), or another primary reforming unit, is omitted. Thereby, a reduction in plant size is also achieved.

The plant is arranged to feed at least a part of the off-gas stream from said hydrogen purification unit as an off-gas recycle stream to the feed side of the ATR; and/or said plant is arranged to feed at least a part of the off-gas stream from said hydrogen purification unit as an off-gas recycle stream to the feed side of the shift section.

Recycling of the off-gas recycle stream to the ATR provides the further advantage of possibly reducing the flow to the prereformer, and thereby reducing its size. More specifically, the recycling of off-gas increases the hydrogen recovery and thereby the feed consumption is reduced. Due to this, the upstream equipment may reduce in size.

Recycling of the off-gas recycle stream to the shift section provides the further advantage of reducing the size of both ATR and prereformer. This recycle option is preferably combined with a second H₂ purification step on the off-gas to reduce H₂ partial pressure.

In another embodiment according to the first aspect of the invention, said plant further comprises a hydrogen-recycling compressor for feeding a portion of said high-purity H₂ stream into said hydrocarbon feed prior to it being fed to the feed side of said at least one pre-reformer unit or prior to it being fed to the feed side of said hydrogenator. Thereby, the energy consumption is further reduced, as hydrogen produced in the process is used in the main hydrocarbon feed prior to it entering the hydrogenator instead of using external hydrogen sources. In other words, the addition of hydrogen to the main hydrocarbon feed further increases the energy efficiency of the plant and process.

Preferably, said plant further comprises a compressor i.e. off-gas recycle compressor arranged for compressing said off-gas recycle stream prior to it being fed to the feed side of the ATR, or to the feed side of the shift section, or to the feed side of the prereformer unit, or prior to it being mixed with hydrocarbon feed before being fed to the feed side of the ATR, or prior to it being mixed with hydrocarbon feed before being fed to the feed side of the prereformer unit, or prior to it being fed to the feed side of the hydrogen drogenator unit. At least a part of the compressed part of the off-gas stream, i.e. the off-gas recycle stream, is used in the process by directly becoming a part of the hydrocarbon feed or process gas being treated in the prereformer, or ATR, or shift section. The uncompressed portion of the off-gas recycle stream is used as fuel for example for the fired heater(s).

In an embodiment according to the first aspect of the invention, said plant is without a fired heater, i.e. the plant is absent of a fired heater arranged to pre-heat said hydrocarbon feed prior to it being fed to the ATR and/or prior to it being fed to the at least one prerefomer unit, for instance where the plant is arranged for the inlet temperature of the hydrocarbon feed to the ATR matching the outlet temperature of the sulfur absorption unit, for instance in the range e.g. 300-400° C., as explained farther above.

In another embodiment according to the first aspect of the invention, said plant further comprises a heater, such as electrical heater or a fired heater, for instance a single fired heater, arranged to pre-heat said hydrocarbon feed prior to it being fed to the ATR and/or prior to it being fed to the at least one prerefomer unit. The electrical heater may be powered by a renewable source, such as power derived from solar or wind. In a particular embodiment, said plant is arranged to feed at least a part of the off-gas stream from said hydrogen purification unit as fuel for said fired heater. In another particular embodiment, said plant is arranged to feed a portion of the H₂-rich stream as fuel for said fired heater.

Optionally, as recited farther above, no heating takes place during normal operation between the (last) prereformer outlet and the ATR inlet.

Accordingly, by the invention, instead of only using the H₂-rich stream as a hydrogen product for end customers, which would normally be the choice to follow, part of the H₂-rich stream, e.g. a small fraction of the H₂-rich stream, is utilized as make-up fuel along with the off-gas stream. This hydrogen balances the duty requirement in the fired heater, where a fired heater is utilized. The off-gas stream is suitably the rest of the off-gas stream which is not recycled back to the prereformer unit or the ATR or the shift section, hence to the hydrocarbon feed or process gas. Thereby, even lower carbon emissions (CO₂ emissions) are achieved as well as higher carbon capture, for instance 97% or more.

It would be understood that the term “process gas” refers to any gas stream being treated in the hydrogenator unit and sulfur absorption unit, or in the prereformer, or in the ATR, or in the shift section, optionally in the carbon dioxide removal section or in the hydrogen purification unit.

The term “at least a part of the off-gas stream from said hydrogen purification unit” means the uncompressed part of the off-gas stream. This stream is then used as fuel for the fired heater and is used optionally also together with separate fuel gas and combustion air. The fired heater, apart from preheating the hydrocarbon feed gas to the prereformer and ATR, may also be used for example for superheating steam.

The off-gas stream may also be used as fuel for steam superheaters.

In another embodiment according to the first aspect of the invention, the plant comprises a steam superheater which is arranged for being heated by shifted syngas preferably downstream the high temperature shift. This further reduces the additional firing of make-up fuel in the fired heater and improves the carbon recovery and enables lower emissions.

In another embodiment according to the first aspect of the invention, the high temperature shift (HTS) unit comprises a promoted zinc-aluminium oxide based high temperature shift catalyst, preferably arranged within said HTS unit in the form of one or more catalyst beds, and preferably wherein the promoted zinc-aluminium oxide based HTS catalyst comprises in its active form a Zn/Al molar ratio in the range 0.5 to 1.0 and a content of alkali metal in the range 0.4 to 8.0 wt % and a copper content in the range 0-10% based on the weight of oxidized catalyst, as for instance disclosed in applicant's US2019/0039886 A1.

In a conventional hydrogen plant the standard use of iron based high temperature shift catalyst re-quires a steam/carbon ratio of around 3.0 to avoid iron carbide formation.

5Fe₃O₄+32CO↔3Fe₅C₂+26CO₂ (1)

Formation of iron carbide will weaken the catalyst pellets and may result in catalyst dis-integration and pressure drop increase.

Iron carbide will catalyse Fischer-Tropsch by-product formation

nCO+(n+m/2)H₂↔CₙHₘ+nH₂O (2)

The Fischer-Tropsch reactions consume hydrogen, whereby the efficiency of the shift section is reduced.

In advantageous embodiments of the process the zinc-aluminum oxide based catalyst in its active form comprises a mixture of zinc aluminum spinel and zinc oxide in combination with an alkali metal selected from the group consisting of Na, K, Rb, Cs and mixtures thereof, and optionally in combination with Cu. The catalyst, as recited above, may have a Zn/Al molar ratio in the range 0.5 to 1.0, a content of alkali metal in the range 0.4 to 8.0 wt % and a copper content in the range 0-10% based on the weight of oxidized catalyst.

The high temperature shift catalyst used according to the present process is not limited by strict requirements to steam to carbon ratios, such as the above-mentioned value of around 3.0 to avoid iron carbide formation, which makes it possible to reduce steam/carbon ratio in the shift section as well as in the reforming section.

Significant reduction in the amount of steam carried in the plant and/or process is obtained, thereby reducing plant size and energy consumption. More specifically, a steam/carbon ratio of less than 2.0, yet 0.4 or 0.6 or even higher, such as 0.8, in the ATR has several advantages. Reducing steam/carbon ratio on a general basis leads to reduced feed plus steam flow through the reforming section and the downstream cooling and hydrogen purification sections. Low steam/carbon ratio in the reforming section and shift section enables also higher syngas throughput compared to high steam/carbon ratio. Reduced mass flow through these sections means smaller equipment and piping sizes. The reduced mass flow also results in reduced production of low temperature calories, which can often not be utilised. This means that there is a potential for both lower capital expenses and operating expenses.

As the requirements to the steam/carbon ratio in the high temperature shift step by the present process is significantly reduced compared to known technologies, it is possible by the present invention to reduce steam/carbon ratio through the front-end to e.g. 0.4 or 0.6 or 0.8. An advantage of a low steam/carbon ratio of the ATR and in the shift section is that smaller equipment is required in the front-end due to the lower total mass flow through the plant, as already recited above.

It would be understood that the term “front-end” means the reforming section. It would also be understood that the reforming section is the section of the plant comprising units up to and including the ATR, i.e. the ATR, or a pre-reformer unit and the ATR, or hydrogenator and sulfur absorber and a pre-reformer unit and ATR.

The plant preferably comprises also an air separation unit (ASU) which is arranged for receiving an air stream and produce an oxygen stream which is then fed through a conduit to the ATR. Preferably, the oxygen comprising stream contains steam added to the ATR. Examples of oxidant comprising stream are: oxygen, mixture of oxygen and steam, mixtures of oxygen, steam, and argon, and oxygen enriched air.

The temperature of the synthesis gas at the exit of the ATR is between 900 and 1100° C., or 950 and 1100° C., typically between 1000 and 1075° C. This hot effluent synthesis gas which is withdrawn from the ATR (syngas from the ATR) comprises carbon monoxide, hydrogen, carbon dioxide, steam, residual methane, and various other components including nitrogen and argon.

Autothermal reforming (ATR) is described widely in the art and open literature. Typically, the ATR comprises a burner, a combustion chamber, and catalyst arranged in a fixed bed all of which are contained in a refractory lined pressure shell. ATR is for example described in Chapter 4 in “Studies in Surface Science and Catalysis”, Vol. 152 (2004) edited by Andre Steynberg and Mark Dry, and an overview is also presented in “Tubular reforming and autothermal reforming of natural gas—an overview of available processes”, Ib Dybkjr, Fuel Processing Technology 42 (1995) 85-107.

The plant preferably comprises also conduits for the addition of steam to the hydrocarbon feed, to the oxygen comprising stream and to the ATR, and optionally also to the inlet of the reforming section e.g. to the hydrocarbon feed, and also to the inlet of the shift section in particular to the HTS unit, and/or to additional shift units downstream the HTS unit, as it will be described farther below.

In another embodiment according to the first aspect, the shift section comprises one or more additional high temperature shift units in series.

In an embodiment according to the first aspect of the invention, said shift section further comprises one or more additional shift units downstream the HTS unit, wherein the one or more additional shift units are one or more medium temperature shift (MTS) units and/or one or more low temperature shift (LTS) units (150), wherein the plant is arranged to provide a LTS inlet temperature below 250° C., such as 190-250° C., and/or wherein the plant is arranged to provide a steam-to-carbon ratio in the shift section of 0.7-1.0a, such as 0.8.

The lower temperature in the LTS and relatively low steam-to-carbon ratio further increases carbon capture and hydrogen production.

As used herein, the term “steam-to-carbon ratio in the shift section” means after adding optional steam to the syngas stream prior to entering the shift section and/or within the shift section, for instance in between a HTS unit and LTS unit. It would also be understood, that the term “steam-to-carbon-ratio in the overall process/plant” includes this optional steam added prior to entering the shift section or in within the shift section, for instance in between a HTS unit and LTS unit.

The provision of additional shifts units or shifts steps adds flexibility to the plant and/or process when operation at low steam/carbon ratios. The low steam/carbon ratio may result in a lower than optimal shift conversion which means that in some embodiments it may be advantageous to provide one or more additional shift steps. The one or more additional shift steps may include a medium temperature (MT) shift and/or a low temperature (LT) shift and/or a high temperature shift. Generally speaking, the more converted CO in the shift steps the more gained H₂ and the smaller front end required.

This is also seen from the exothermic shift reaction: CO+H₂O↔CO₂+H₂+heat

Steam may optionally be added before and after the high temperature shift step such as before one or more following MT or LT shift and/or HT shift steps in order to maxim-ize performance of said following HT, MT and/or LT shift steps.

Having two or more high temperature shift steps in series (such as a high temperature shift step comprising two or more shift reactors in series e.g. with the possibility for cooling and/or steam addition in between) may be advantageous as it may provide increased shift conversion at high temperature which gives a possible reduction in required shift catalyst volume and therefore a possible reduction in capital expenditure (CapEx). Furthermore, high temperature reduces the formation of methanol, a typical shift step byproduct.

Preferably the MT and LT shift steps may be carried out over promoted cop-per/zinc/alumina catalysts. For example, the low temperature shift catalyst type may be LK-821-2, which is characterized by high activity, high strength, and high tolerance towards sulphur poisoning. A top layer of a special catalyst may be installed to catch possible chlorine in the gas and to prevent liquid droplets from reaching the shift catalyst.

The MT shift step may be carried out at temperatures at 190-360° C.

The LT shift step may be carried out at temperatures at T_{dew}+15-290° C., such as, 200-280° C. For example, the low temperature shift inlet temperature is from T_{dew}+15-250° C., such as 190-210° C.

Reducing the steam/carbon ratio leads to reduced dew point of the process gas, which means that the inlet temperature to the MT and/or LT shift steps can be lowered. A lower inlet temperature can mean lower CO slippage outlet the shift reactors, which is also advantageous for the plant and/or process.

It is well known that MT/LT shift catalysts are prone to produce methanol as byproduct. Such byproduct formation can be reduced by increasing steam/carbon. The CO₂ wash which may follow the MT/LT shifts requires heat for regeneration of the CO₂ absorption solution. This heat is normally provided as sensible heat from the process gas but this is not always enough. Typically, an additionally steam fired reboiler is providing the make-up duty. Optionally adding steam to the process gas can replace this additionally steam fired reboiler and simultaneously ensures reduction of byproduct formation in the MT/LT shift section.

Accordingly, in another embodiment according to the first aspect of the invention, the plant further comprises a methanol removal section arranged between the shift section and said CO₂ removal section, said methanol removal section being arranged to separate a methanol-rich stream from said shifted syngas stream. The methanol formed by the MT/LT shift catalyst can optionally be removed from the synthesis gas in a water wash to be placed upstream the CO₂ removal step or in the CO₂ product stream.

In another embodiment according to the first aspect of the invention, the hydrogen purification unit is selected from a pressure swing adsorption (PSA) unit, a hydrogen membrane or a cryogenic separation unit, preferably a PSA.

By the invention, the reforming section comprises an ATR and optionally also a pre-reforming unit, yet there is no steam methane reforming (SMR) unit, i.e. the use of a conventional SMR, also normally referred as radiant furnace, or tubular reformer, or another primary reforming unit, is omitted.

SMR-based plants typically operate with a steam-to-carbon ratio of about 3. While omitting the use of SMR would convey significant advantages in terms of energy consumption and plant size, since the ATR enables operation at steam to carbon ratios well below 1 and thereby significantly reduce the amount of steam carried in the plant/process, a hydrogen purification unit such as a Pressure Swing Adsorption (PSA) unit is suitably used to enrich the content of hydrogen from a CO₂-depleted syngas stream obtained after the CO₂-removal.

In another embodiment according to the first aspect of the invention, the CO₂ removal section is selected from an amine wash unit, or a CO₂ membrane i.e. CO₂ membrane separation unit, or a cryogenic separation unit, preferably an amine wash unit.

In an embodiment, the amine wash unit comprises a CO₂-absorber and a CO₂-stripper as well as a high-pressure flash drum and low-pressure flash drum, thereby separating a CO₂-rich stream containing more than 99 vol. % CO₂ such as 99.5 vol. % CO₂ or 99.8 vol. % CO₂, a H₂-rich stream containing 98 vol. % hydrogen, as well as a high pressure flash gas containing about 60 vol. % CO₂ and 40 vol. % H₂. In the amine wash unit, in the first high pressure flash step via said high-pressure drum, the bulk part of the impurities is released together with some CO₂ to the gas phase as a high-pressure flash gas. In the low-pressure flash step via said low-pressure flash drum, mainly CO₂ is released to a final product as a CO₂-rich stream.

In particular, when using a CO₂-membrane, the permeate is the stream richer in hydrogen and which is then passed to hydrogen purification unit, e.g. PSA unit, while the retentate is a hydrogen-lean stream which is recycled to the feed side of the ATR, or feed side of shift section, or the feed side i.e. inlet side of the membrane separation.

The CO₂ removal section can also be a Benfield process or plant comprising an absorber for conducting a gas absorbing step and a regenerator for conducting a carbonate regeneration step. The CO₂ removal section can also be in the form of a CO₂ PSA, as is also well known in the art.

In many advantageous embodiments, a CO₂ removal step may be carried out after/downstream the one or more shift steps. Removing the CO₂ from the synthesis gas (shifted synthesis gas) reduces the size of the hydrogen purification section. The off-gas from the hydrogen purification section or hydrogen purification unit, e.g. PSA unit, will be free from or lean in CO₂ thus increasing its heating value and fuel efficiency. The off-gas may be exported as a low CO₂ containing fuel gas. The off-gas may be used as fuel in a fired heater for steam production at low CO₂ emission. Since the CO₂ has been removed from the off-gas it may be recycled to i.e. inlet of the prereformers, inlet prereformer preheater, inlet ATR or inlet ATR preheater. Recycling the CO₂ depleted off-gas from hydrogen purification section reduces the consumption of feed gas to the unit. It also reduces steam export if the off-gas was otherwise used as fuel in a fired heater for steam production. Not least, it enables the plant and process to operate with reduced CO₂ emissions. In standard design the CO₂ content is 500 ppmv or even lower such as 50 ppmv, in the treated gas, i.e. in the CO₂-depleted shifted syngas, as mentioned previously.

Hence, carbon dioxide can be prepared having a quality that allows it to be reused or stored, thus reducing overall CO₂ emission in the plant and/or process. While there may be a small slip of carbon dioxide through the burning of off-gas, by the invention it is possible to remove close to 100% CO₂.

In preferred embodiments a CO₂ removal step may be used to bring the CO₂ content down to less than 500 or 400 ppmv CO₂, such as below 100 ppmv or in some preferred embodiments down to 50 ppmv or 20 ppmv or below.

The CO₂ from the CO₂ removal step may in principle be vented to atmosphere, yet preferably it is captured and used for other purposes to reduce the CO₂ emission to the atmosphere. For instance, the separated CO₂ may be sequestered in geological structures or used as industrial gas for various purposes. The carbon in the hydrocarbon feed is thus captured as CO₂.

After the one or more shift sections and CO₂ removal unit the gas may contain residual CO and CO₂ together with small amounts of CH₄, Ar, He and H₂O.

In another embodiment according to the first aspect of the invention, the CO₂ removal section is a CO₂ membrane, said CO₂ membrane is arranged to produce a hydrogen-rich permeate stream for further enrichment in said hydrogen purification unit and a hydrogen-lean retentate stream, wherein said plant is arranged to feed at least a part of the hydrogen-lean retentate stream from said CO₂ membrane as a hydrogen recycle stream to the feed side of the ATR, and/or wherein said plant is arranged to feed at least a part of the hydrogen-lean retentate stream from said CO₂ membrane as a hydrogen recycle stream to the feed side of the shift section. Also, the plant may be arranged to feed at least a part of the hydrogen-lean retentate stream from said CO₂ membrane as a hydrogen recycle stream to the inlet of the CO₂ membrane.

In another embodiment according to the first aspect of the invention, the CO₂ removal section is a cryogenic separation unit, said cryogenic separation unit is arranged to produce a cryogenic unit CO₂-rich stream, optionally an off-gas stream and said CO₂-depleted shifted syngas stream,
wherein said plant is arranged to feed at least a part of the off-gas stream from said cryogenic separation unit as a cryogenic off-gas recycle stream to the feed side of the ATR,
and/or wherein said plant is arranged to feed at least a part of the off-gas stream from said cryogenic separation unit as a cryogenic off-gas recycle stream to the feed side of the shift section,
and/or wherein said plant is arranged to feed at least a part of the off-gas stream from said cryogenic separation unit as a cryogenic off-gas recycle stream to the feed side i.e. inlet of said cryogenic separation unit.

In another embodiment according to the first aspect of the invention, said plant further comprises a compressor i.e. off-gas recycle compressor (compressor for the off-gas stream from the hydrogen purification unit) arranged for compressing said off-gas recycle stream, and a membrane separation unit for separating the thus compressed off-gas recycle stream into a permeate membrane stream and a retentate membrane stream, said compressor being adapted upstream said membrane separation unit, said permeate membrane stream being hydrogen rich,
and
said plant is arranged for recycling said permeate membrane stream, optionally via a compressor, to the feed side i.e. inlet of the hydrogen purification unit, and/or said plant is arranged for mixing said permeate membrane stream with said high purity hydrogen stream from the hydrogen purification unit, and for recycling said membrane retentate as fuel for said at least one fired heater.

In an embodiment, the shifted syngas i.e. the shifted gas stream, is directly sent to a hydrogen purification unit, e.g. PSA unit, and then the off-gas generated is passed through a compressor and a CO₂ removal. As used herein, “directly sent to a hydrogen purification unit” means that there is no CO₂-removal of the shifted syngas upstream the hydrogen purification unit. Accordingly, in an embodiment, the plant is absent of a CO₂ removal section downstream the shift section and upstream the hydrogen purification unit, and further comprises a compressor i.e. off-gas recycle compressor (compressor for the off-gas stream from the hydrogen purification unit) arranged for compressing said off-gas recycle stream, and a CO₂ separation unit for removal of CO₂ from the thus compressed off-gas recycle stream into a CO₂-rich off-gas stream and a CO₂-lean off-gas stream, said compressor being adapted upstream said CO₂ separation unit,
and
said plant is arranged for recycling said CO₂-lean off-gas stream, optionally via a compressor, to the feed side of the ATR, and/or to the feed side of the shift section, and/or to the feed side of the hydrogen purification unit, and/or as fuel for said at least one fired heater.

In a second aspect of the invention, there is also provided a process for producing a H₂-rich stream from a hydrocarbon feed, said process comprising the steps of:
providing a plant according to the first aspect of the invention;
supplying a hydrocarbon feed to the ATR, and converting it to a stream of syngas;
supplying a stream of syngas from the ATR to the shift section, and shifting it in a high temperature shift step, thereby providing a shifted syngas stream;
supplying the shifted gas stream from the shift section to the CO₂ removal section, and separating a CO₂-rich stream from said shifted syngas stream, thereby providing a CO₂-depleted shifted syngas stream,
supplying said CO₂-depleted shifted syngas stream from said CO₂ removal section to a hydrogen purification unit, and separating it into a high-purity H₂ stream and an off-gas stream;
wherein the process is absent of primary reforming;
wherein the process comprises feeding at least a part of the off-gas stream (9) from said hydrogen purification unit (125) as an off-gas recycle stream (9′) to the feed side of the ATR (110); and/or as an off-gas recycle stream (9″) to the feed side of the shift section; and
wherein the inlet temperature of said hydrocarbon feed (2) to the ATR is below 600° C., such as 550° C. or 500° C. or lower, for instance 300-400° C.

It would be understood that the use of the article “a” in a given item, refer to the same item in the first aspect of the invention. For instance, the term “a high purity H₂ stream” refers to the high purity H₂ stream in accordance with the first aspect of the invention.

In an embodiment according to the second aspect of the invention, the process comprises: pre-reforming said hydrocarbon feed prior to it being fed to the ATR; and feeding at least a part of the off-gas stream from said hydrogen purification unit as an off-gas recycle stream to the feed side of the prereformer unit.

Preferably one or more prereforming units are provided as part of the reforming section and upstream the ATR. In the prereforming unit(s) all higher hydrocarbons can be converted to carbon oxides and methane, but the prereforming unit(s) are also advantageous for light hydrocarbons. Providing the prereforming unit(s), hence prereforming step(s), may have several advantages including reducing the required O₂ consumption in the ATR and allowing higher inlet temperatures to the ATR since cracking risk by preheating is minimized. Furthermore, the prereforming unit(s) may provide an efficient sulphur guard resulting in a practically sulphur free feed gas entering the ATR and the downstream system. Moreover, as explained in connection with the first aspect of the invention, by feeding at least a part of the off-gas stream to a prereforming unit, the methane content of the off-gas stream is reduced, thereby resulting in an even higher carbon capture of the carbon of the hydrocarbon feed, for instance 95% or more of the carbon in the natural gas feed is captured or recovered.

The prereforming step(s) may be carried out at temperatures between 300-650° C., preferably 390-480° C. Preferably, the prereforming is conducted in one or more adiabatic prereforming stages with interstage preheating, i.e. with heating in between prereforming stages.

In another embodiment, there is no prereforming step.

In an embodiment according to the second aspect of the invention, the process further comprises adding steam to: the ATR, the hydrocarbon feed, and/or the syngas stream prior to entering the shift section.

In an embodiment according to the second aspect of the invention, the steam-to-carbon ratio in the ATR is 0.6 or higher, such as 0.8 or higher, yet said steam-to-carbon ratio being not greater than 2.0, such as 0.9, 1.0 or higher, for instance in the range 1.0-2.0, and/or wherein the ATR is arranged to operate at 20-30 barg, such as 24-28 barg.

In an embodiment according to the second aspect of the invention, the process comprises pre-heating said hydrocarbon feed prior to it being fed to the ATR and/or prior to it being fed to the at least one prerefomer unit, in a heater, such as an electrical heater or a fired heater, preferably a single fired heater, and feeding at least a part of the off-gas stream and/or a portion of the H₂-rich stream from said hydrogen purification unit as fuel for said fired heater.

In an embodiment according to the second aspect of the invention, said shift section comprises one or more additional shift units downstream the high temperature shift unit, wherein the one or more additional shift units are one or more medium temperature shift units and/or one or more low temperature shift units, wherein the low temperature shift inlet temperature is below 250° C. such as 190-250° C., and/or wherein the steam-to-carbon ratio in the shift section is 0.7-1.0, such as 0.8.

In another embodiment according to the second aspect of the invention, the temperature in the high temperature shift step is in the range 300-600° C., such as 360-470° C., or such as 345-550° C. This means that according to the present process it is possible to run a high temperature shift reaction on a feed with much lower steam/carbon ratio than possible by known processes. For example, the high temperature shift inlet temperature may be 300-400° C., such as 350-380° C.

The carbon feed for the ATR is mixed with oxygen and additional steam in the ATR, and a combination of at least two types of reactions take place. These two reactions are combustion and steam reforming.

Combustion Zone:

2H₂+O₂↔2H₂O+heat (3)

CH₄+3/2O₂↔CO+2H₂O+heat (4)

Thermal and Catalytic Zone:

CH₄+H₂O+heat↔CO+3H₂ (5)

CO+H₂O↔CO₂+H₂+heat (6)

The combustion of methane to carbon monoxide and water (reaction (4)) is a highly exothermic process. Excess methane may be present at the combustion zone exit after all oxygen has been converted.

The thermal zone is part of the combustion chamber where further conversion of the hydrocarbons proceeds by homogenous gas phase reactions, mostly reactions (5) and (6). The endothermic steam reforming of methane (5) consumes a large part of the heat developed in the combustion zone.

Following the combustion chamber there may be a fixed catalyst bed, the catalytic zone, in which the final hydrocarbon conversion takes place through heterogeneous catalytic reactions. At the exit of the catalytic zone, the synthesis gas preferably is close to equilibrium with respect to reactions (5) and (6).

In an embodiment, the process operates with no additional steam addition between the reforming step(s) and the high temperature shift step.

In another embodiment according to the second aspect of the invention, the space velocity in the ATR is low, such as less than 20000 Nm³ C/m³/h, preferably less than 12000 Nm³ C/m³/h and most preferably less 7000 Nm³ C/m³/h. The space velocity is defined as the volumetric carbon flow per catalyst volume and is thus independent of the conversion in the catalyst zone.

In another embodiment according to the second aspect of the invention, the synthesis gas is washed with water to reduce the methanol content, preferably between the shift step and the CO₂-removal step.

In another embodiment according to the second aspect of the invention, the CO₂ depleted shifted gas stream comprises less than 500 or 400 ppmv CO₂, such as below 100 ppmv, or below 50 or 20 ppmv CO₂.

In another embodiment according to the second aspect of the invention, the process further comprises subjecting the one or more high-purity H₂ streams, i.e. here the high-purity H₂ stream from the hydrogen purification unit, to one or more hydrogen purification steps.

In another embodiment according to the second aspect of the invention, the CO₂ removal section is a CO₂-membrane producing i) said CO₂-depleted shifted syngas stream, said CO₂-depleted shifted syngas stream being a hydrogen-rich permeate stream for further hydrogen enrichment in said hydrogen purification unit, and ii) a hydrogen-lean retentate stream; and feeding at least a part of said hydrogen-lean retentate stream as a hydrogen recycle stream to the feed side of the ATR, and/or feeding at least a part of the hydrogen-lean retentate stream as a hydrogen recycle stream to the feed side of the shift section.

In another embodiment according to the second aspect of the invention, the CO₂ removal section is a cryogenic separation unit producing a cryogenic unit CO₂-rich stream, optionally an off-gas stream and said CO₂-depleted shifted syngas stream, and feeding at least a part of the off-gas stream from said cryogenic separation unit as a cryogenic off-gas recycle stream to the feed side of the ATR, and/or feeding at least a part of the off-gas stream from said cryogenic separation unit as a cryogenic off-gas recycle stream to the feed side of the shift section, and/or feeding at least a part of the off-gas stream from said cryogenic separation unit as a cryogenic off-gas recycle stream to the feed side i.e. inlet of said cryogenic separation unit.

In another embodiment according to the second aspect of the invention, the process further comprises a compressor i.e. off-gas recycle compressor (compressor for the off-gas stream from the hydrogen purification unit) thereby providing a step for compressing said off-gas recycle stream, and a membrane separation unit thereby providing a step for separating the thus compressed off-gas recycle stream into a permeate membrane stream and a retentate membrane stream, said compressing step being conducted prior to said membrane separating step, said permeate membrane stream being hydrogen rich,
and
recycling said permeate membrane stream, optionally via a compressing step, to the feed side i.e. inlet of the hydrogen purification unit, and/or mixing said permeate membrane stream with said high purity hydrogen stream from the hydrogen purification unit, and recycling said membrane retentate as fuel for said at least one fired heater.

In an embodiment, the shifted syngas i.e. the shifted gas stream, is directly sent to a hydrogen purification unit, e.g. PSA unit, and then the off-gas generated is passed through a compressor and a CO₂ removal. Accordingly, in an embodiment, the process is absent of a CO₂ removal section downstream the shift section and upstream the hydrogen purification unit, and the process further comprises a compressor i.e. off-gas recycle compressor (compressor for the off-gas stream from the hydrogen purification unit) thereby providing a step for compressing said off-gas recycle stream, and a CO₂ separation unit thereby providing a step for removing CO₂ from the thus compressed off-gas recycle stream into a CO₂-rich off-gas stream and a CO₂-lean off-gas stream, said compressing step being conducted prior to said CO₂ separation unit,
and
recycling said CO₂-lean off-gas stream, optionally via a compressing step, to the feed side of the ATR, and/or feed side of the shift section, and/or feed side of the hydrogen purification unit, and/or as fuel for said at least one fired heater.

It would be understood that any of the embodiments and associated benefits of the first aspect may be used in connection with any of the embodiments of the second aspect, or vice versa.

The invention according to the first or second aspect has at least the following technical advantages:
a process and/or plant enabling a process scheme utilizing proven reforming technology (ATR) operating with low steam/carbon ratio.
a process and/or plant enabling operation of the high temperature shift (HTS) downstream the reforming section at the same low steam/carbon ratio as the reforming section.
a process and/or plant enabling a process scheme with CO₂ removal and recycling of off-gas from the hydrogen purification unit as feed gas to the process, i.e. reforming process, or shift process.
a process and/or plant enabling maximum line capacity.
a process and/or plant having a significant reduction in CO₂-emission, particularly when the imported energy is from renewable sources, such as solar or wind.
a process and/or plant capable of achieving 95% or more carbon capture of the hydrocarbon feed and at the same time not compromising with the energy efficiency.
a process and/or plant having better energy efficiency than a plant where CO₂ is removed from the flue gas.

### BRIEF DESCRIPTION OF THE FIGURES

FIGS. 1 and 2 illustrate layouts of the ATR-based hydrogen process and plant. FIG. 2 comprises the elements of FIG. 1, plus the additional steps of methanol removal and CO₂ removal and different feeding points of an off-gas stream from the hydrogen purification unit.

### DETAILED DESCRIPTION

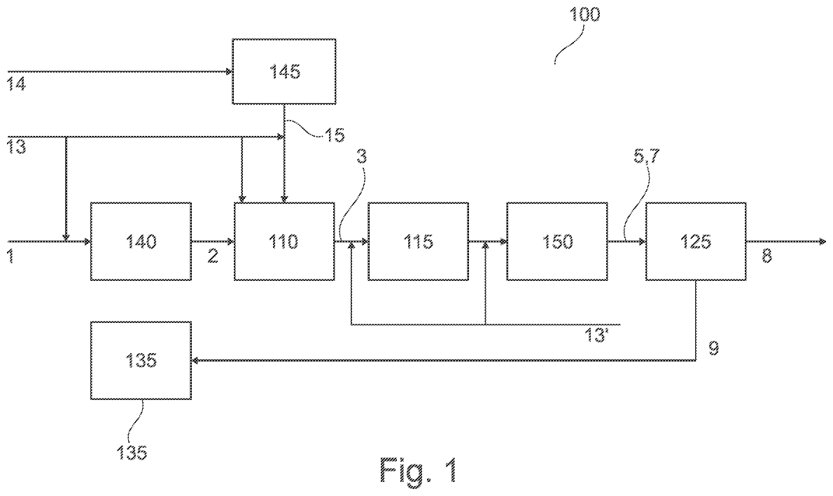

FIG. 1 shows a plant 100 in which a hydrocarbon feed 1, i.e. main hydrocarbon feed 1, such as natural gas, is passed to a reforming section comprising a pre-reforming unit 140 and autothermal reformer 110. The reforming section may also include a hydrogenator and sulfur absorber unit (not shown) upstream the pre-reforming unit 140. The hydrocarbon steam 1 is mixed with steam 13 and optionally also with a portion of a hydrogen-rich stream 8 from a first hydrogen purification unit 125 located downstream. The resulting hydrocarbon feed 2 is fed to ATR 110, as so is oxygen 15 and steam 13. The oxygen stream 15 is produced by means of an air separation unit (ASU) 145, to which air 14 is fed. In the ATR 110, the hydrocarbon feed 2 is converted to a stream of syngas 3, which is then passed to a shift section. The hydrocarbon feed 2 enters the ATR at 650° C. and the temperature of the oxygen is around 253° C. The steam/carbon ratio in the ATR e.g. 0.8, 0.6 or 0.4 and the pressure lower than 30 barg, for instance 24-28 barg. This syngas, here being the process gas 3 exits the ATR at about 1050° C. through a refractory lined outlet section and transfer line to the waste heat boilers in the process gas cooling section.

The shift section comprises a high temperature shift (HTS) unit 115 where additional or extra steam 13′ also may be added upstream. Additional shift units, such as a low temperature shift unit 150 may also be included in the shift section. Additional or extra steam 13′ may also be added downstream the HTS unit 115 but upstream the low temperature shift unit 150. By way of example, in a shift section including high and medium/low temperature shift, the high temperature shift operates under the following conditions: HT shift: Tin/Tout: 330/465° C. (ΔT=135° C.); LT shift: Tin/Tout: 195/250° C. (ΔT=55° C.). After reforming, about 28.3 vol % CO is present in the syngas 3 (dry basis). In the high temperature shift converter, the CO content is reduced to approximately 7.6 vol. %, and the temperature increases from 330° C. to 465° C. The heat content of the effluent from the high temperature CO converter is recovered in a waste heat boiler and in a boiler feed water preheater. The process gas from the high shift converter is thereby cooled to 195° C. and passed on to the medium/low temperature shift converter in which the CO content is reduced to approximately 1.0 vol %, while the temperature increases to 250° C.

From the shift section, a shifted gas stream 5 is thus produced, which is then fed to a CO₂-removal section (not shown). The CO₂-removal section separates a CO₂-rich stream from the syngas stream (5), thereby providing a CO₂-depleted syngas stream (7). This syngas stream (7) is then fed to a hydrogen purification unit 125, e.g. a PSA-unit, from which a H₂-rich stream 8 (high-purity H₂ stream) and an off-gas recycle stream 9 is produced. This off-gas recycle stream 9 serves as fuel for an optional fired heater 135 and optionally also as fuel for steam superheaters. A portion of the H₂-rich stream is optionally also used as fuel (not shown) for the fired heater 135. The fired heater 135 provides for the indirect heating of hydrocarbon feed 1 and hydrocarbon feed 2. Preferably, the off-gas recycle stream 9 to the fired heater is the uncompressed portion of the off-gas stream which has been passed through an off-gas recycle compressor (not shown).

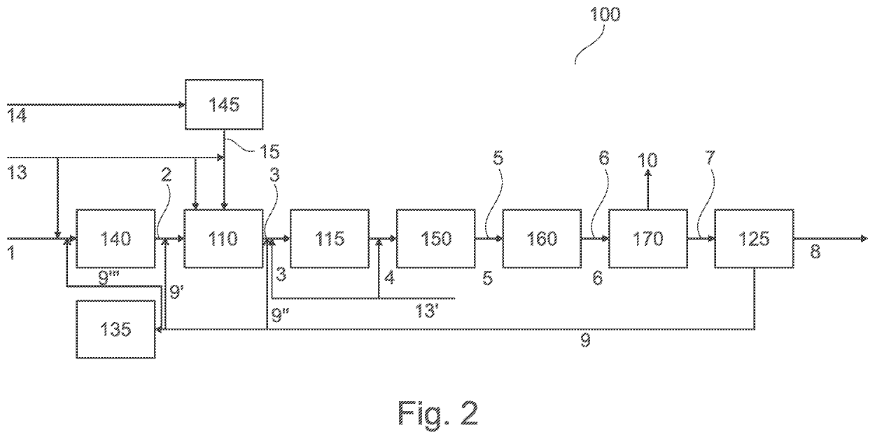

FIG. 2 shows specific embodiments of the invention in addition to the elements of FIG. 1, in the form of a methanol removal and water wash section 160 and CO₂-removal section 170, as well as feeding points of the off-gas 9 from the hydrogen purification unit 125.

From the shift section, a shifted gas stream 5 is produced, which is fed to the optional methanol removal and water wash section 160, thereby producing a feed syngas stream 6 which is then fed to the CO₂-removal section 170 comprising e.g. a CO₂-absorber and a CO₂-stripper. In the CO₂-removal section 170, the CO₂ content in the outlet stream from shift section (shifted gas stream 5) is reduced to 20 ppmv. All methanol in the synthesis gas going to the CO₂ removal section will leave this section with the process condensate and the CO₂ product stream. A water wash on the synthesis gas 5 going to the CO₂ removal section or on the CO₂ product stream can minimize the methanol content in the CO₂ product stream 10. The CO₂-removal section separates such CO₂-rich stream 10 from the syngas stream 5, thereby providing a CO₂-depleted syngas stream 7. This syngas stream 7 is then fed to a hydrogen purification unit 125, e.g. a PSA-unit, from which a H₂-rich stream 8 and an off-gas stream 9 are produced. The plant 100 is arranged to feed at least a part of the off-gas stream 9 from said hydrogen purification unit 125 as an off-gas recycle stream 9′ to the feed side of the ATR 110, and/or as an off-gas recycle stream 9″ to the feed side of the shift section, and/or as an off-gas recycle stream 9′″ to the feed side of the prereformer unit 140, e.g. by mixing with natural gas feed 1 upstream a prereformer feed preheater (not shown). Thereby the carbon capture in the hydrocarbon feed is further increased. Preferably, the off-gas recycle stream 9′, 9″, 9′″ to respectively the ATR (110), shift (HTS unit 115) and pre-reformer unit (140) is the compressed portion of the off-gas stream 9 which has been passed through an off-gas recycle compressor (not shown). The off-gas recycle stream 9 may also serve as fuel for a fired heater 135 and optionally also as fuel for steam superheaters, as described in connection with FIG. 1.

1. A plant (100) for producing a H₂-rich stream from a hydrocarbon feed, said plant comprising:
an autothermal reformer (ATR), said ATR being arranged to receive a hydrocarbon feed and convert it to a stream of syngas;
a shift section, said shift section comprising a high temperature shift unit, said high temperature shift unit being arranged receive the stream of syngas from the ATR and shift it in a high temperature shift step, thereby providing a shifted syngas stream;
a CO₂ removal section, arranged to receive the shifted syngas stream from said shift section and separate a CO₂-rich stream from said shifted syngas stream, thereby providing a CO₂-depleted shifted syngas stream;
a hydrogen purification unit, arranged to receive said CO₂-depleted shifted syngas stream, from said CO₂ removal section, and separate it into a high-purity H₂ stream and an off-gas stream-;
wherein said plant is absent of a primary reforming unit;
wherein said plant is arranged to feed at least a part of the off-gas stream from said hydrogen purification unit as an off-gas recycle stream to the feed side of the ATR and/or as an off-gas recycle stream to the feed side of the shift section; and
wherein said plant is arranged to provide an inlet temperature of said hydrocarbon feed to the ATR of below 600° C.

2. The plant according claim 1, wherein said plant further comprises at least one prereformer unit arranged upstream the ATR, said prereformer unit being arranged to pre-reform said hydrocarbon feed prior to it being fed to the ATR, and
wherein said plant is arranged to feed at least a part of the off-gas stream from said hydrogen purification unit as an off-gas recycle stream to the feed side of the prereformer unit.

3. The plant according to claim 1, wherein said plant is absent of a prereformer unit.

4. The plant according to claim 1 further comprising:
a hydrogenator unit and a sulfur absorption unit arranged upstream said at least one pre-reformer unit or said ATR, wherein said plant is arranged to feed at least a part of the off-gas stream from said hydrogen purification unit as an off-gas recycle stream to the feed side of the hydrogenator unit; and
wherein the plant is arranged for the outlet temperature of said sulfur absorption unit matching the inlet temperature of the ATR.

5. The plant according to claim 1, wherein said plant is arranged to provide a steam-to-carbon ratio in the ATR of 0.4 or higher, yet said steam-to-carbon ratio being not greater than 2.0, and/or wherein the ATR is arranged to operate at 20-30 barg.

6. The plant of claim 1, wherein said plant further comprises a heater arranged to pre-heat said hydrocarbon feed prior to it being fed to the ATR and/or prior to it being fed to at least one prerefomer unit.

7. The plant according to claim 6, wherein said plant is arranged to feed at least a part of the off-gas stream from said hydrogen purification unit as fuel for said fired heater, and/or wherein said plant is arranged to feed a portion of the H₂-rich stream as fuel for said fired heater.

8. The plant according to claim 1, wherein said plant is absent of a fired heater arranged to pre-heat said hydrocarbon feed prior to it being fed to the ATR and/or prior to it being fed to at least one prerefomer unit.

9. The plant according to claim 1, wherein the hydrogen purification unit is selected from a pressure swing adsorption (PSA) unit, a hydrogen membrane or a cryogenic separation unit.

10. The plant according to claim 1, wherein the CO₂ removal section is selected from an amine wash unit, a CO₂ membrane separation unit, or a cryogenic separation unit.

11. A process for producing a H₂-rich stream from a hydrocarbon feed, said process comprising the steps of:
providing a plant according to claim 1;
supplying a hydrocarbon feed to the ATR, and converting it to a stream of syngas;
supplying a stream of syngas from the ATR to the shift section, and shifting it in a high temperature shift step, thereby providing a shifted syngas stream;
supplying the shifted gas stream from the shift section to the CO₂ removal section, and separating a CO₂-rich stream from said shifted syngas stream, thereby providing a CO₂-depleted shifted syngas stream;
supplying said CO₂-depleted shifted syngas stream from said CO₂ removal section to a hydrogen purification unit, and separating it into a high-purity H₂ stream and an off-gas stream;
wherein the process is absent of primary reforming;
wherein the process comprises feeding at least a part of the off-gas stream from said hydrogen purification unit as an off-gas recycle stream to the feed side of the ATR; and/or as an off-gas recycle stream to the feed side of the shift section; and
wherein the inlet temperature of said hydrocarbon feed to the ATR is below 600° C.

12. The process of claim 11, comprising:
prereforming said hydrocarbon feed prior to it being fed to the ATR, and
feeding at least a part of the off-gas stream from said hydrogen purification unit as an off-gas recycle stream to the feed side of the prereformer unit.

13. The process of claim 11, further comprising adding steam to: the ATR, the hydrocarbon feed, and/or the syngas stream prior to entering the shift section.

14. The process of claim 11, wherein the steam-to-carbon ratio in the ATR is 0.4 or higher, yet said steam-to-carbon ratio being not greater than 2.0, and/or wherein the ATR is arranged to operate at 20-30 barg.

15. The process of claim 11, comprising:
pre-heating said hydrocarbon feed in a heater, such as an electrical heater or a fired heater, prior to it being fed to the ATR, and/or prior to it being fed to at least one prerefomer unit, and
feeding at least a part of the off-gas stream and/or a portion of the H₂-rich stream from said hydrogen purification unit as fuel for said fired heater.
